(19) United States
(12) Patent Application Publication
(10) Pub. No.: US 2022/0053958 A1
(43) Pub. Date: Feb. 24, 2022

(54) NON-SLIP FOAM FLOOR MAT

(71) Applicant: HUI LI WANG, TAICHUNG CITY (TW)

(72) Inventor: HUI LI WANG, TAICHUNG CITY (TW)

(21) Appl. No.: 17/000,789

(22) Filed: Aug. 24, 2020

(51) Int. Cl. A47G 27/02; A47G 27/04; B32B 27/08; B32B 27/06; B32B 3/30

(52) U.S. Cl. CPC A47G 27/0212; A47G 27/0412; B32B 27/08; B32B 2327/06; B32B 3/30; B32B 2471/04; B32B 27/065

(57) ABSTRACT

A non-slip foam floor mat includes a mat body, a plastic film and a non-slip layer. The mat body is made of a foam material. The plastic film is attached to a surface of the mat body. The plastic film has a top surface. The top surface is processed by electric shock or flame to form a plurality of fine dents. The non-slip layer is formed of a non-slip coating coated on the top surface of the plastic film. The non-slip coating is embedded in the fine dents and tightly joined to the plastic film, thereby forming a high friction coefficient to achieve a non-slip effect.

### FIELD OF THE INVENTION

The present invention relates to a floor mat, and more particularly to a non-slip foam floor mat.

### BACKGROUND OF THE INVENTION

A conventional floor mat includes a mat body made of a foam material. Due to the characteristics of the foam material, the surface of the mat body has many fine pores and is not flat, so dirt and dust are easily accumulated and it is difficult to clean the floor mat. After using for a long time, the color of the mat body becomes black or the floor mat has a strong or unpleasant smell. In addition, the surface of the mat body is usually printed with colors or patterns. These decorative surface layers may fall off due to friction when in use, which will affect the appearance.

Therefore, some improved products are developed on the market. As shown in FIG. 3, a layer of plastic film 5 is attached to the surface of a mat body 4, thereby covering the fine pores on the surface of the mat body 4 to prevent the accumulation of dust and dirt and protecting the decoration of the color or pattern on the surface of the mat body 4. However, the surface 51 of the plastic film 5 is very flat and smooth, and its friction coefficient is very low. As a result, the user may slip easily when stepping on it, which may cause a fall or other accidents.

### SUMMARY OF THE INVENTION

The primary object of the present invention is to provide a non-slip foam floor mat that is provided with a non-slip layer having a higher friction coefficient on its surface, so as to achieve a non-slip effect.

In order to achieve the above object, the present invention provides a non-slip foam floor mat, comprising a mat body, a plastic film and a non-slip layer. The mat body is made of a foam material. The plastic film is attached to a surface of the mat body. The plastic film has a top surface. The top surface is processed by electric shock or flame to form a plurality of fine dents. The non-slip layer is formed of a non-slip coating coated on the top surface of the plastic film. The non-slip coating is embedded in the fine dents and tightly joined to the plastic film.

Preferably, the foam material of the mat body is EVA, PVC, PE or rubber.

Preferably, the plastic film is made of PE, HDPE, PC, PP or PVC.

### BRIEF DESCRIPTION OF THE DRAWINGS

FIG. 1 is an exploded view of the present invention;

FIG. 2 is a cross-sectional view of the present invention; and

FIG. 3 is a cross-sectional view of a conventional floor mat.

### DETAILED DESCRIPTION OF THE PREFERRED EMBODIMENTS

Embodiments of the present invention will now be described, by way of example only, with reference to the accompanying drawings.

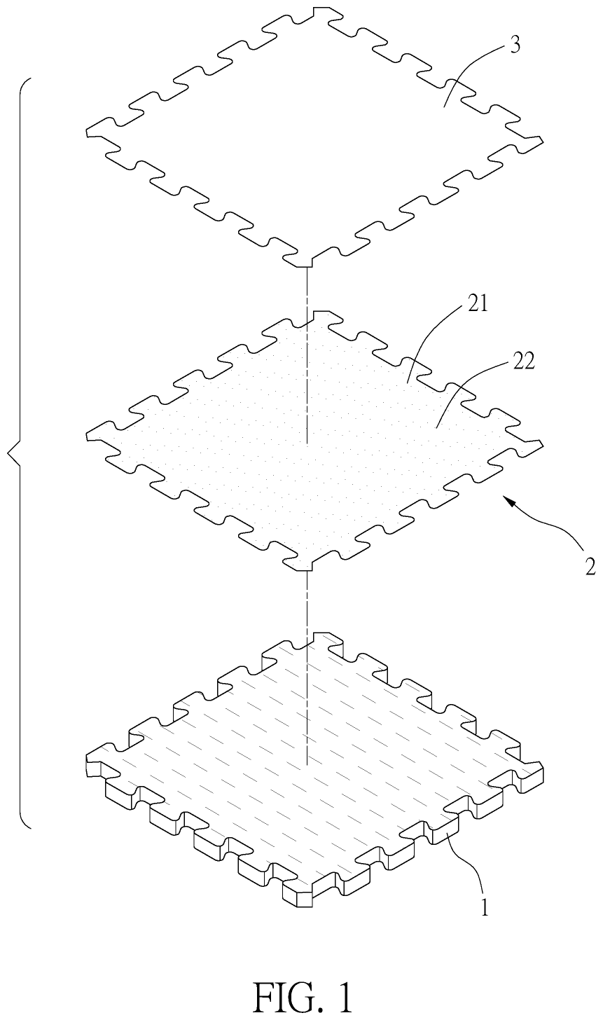

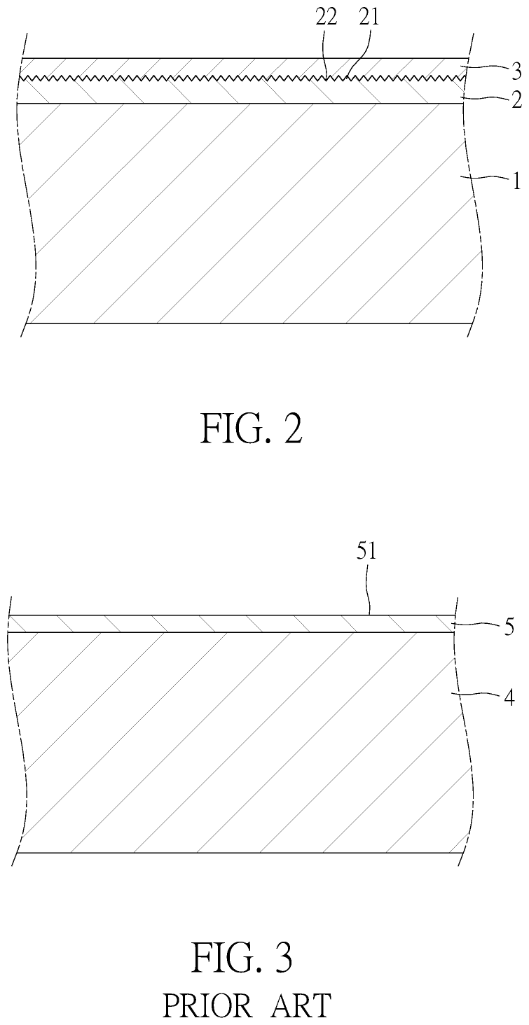

Referring to FIG. 1 and FIG. 2, a non-slip foam floor mat provided by the present invention comprises a mat body 1, a plastic film 2, and a non-slip layer 3. The mat body 1 is made of a foam material selected from EVA, PVC, PE or rubber. The plastic film 2 is made of PE, HDPE, PC, PP or PVC. The non-slip layer 3 is formed of a non-slip coating having a high friction coefficient.

The plastic film 2 is attached to the surface of the mat body 1 to cover most of the fine pores formed on the surface of the mat body 1 based on the foam material, thereby preventing the accumulation of dirt or dust, so as to maintain the hygienic and beautiful appearance of the mat body 1. The plastic film 2 has a top surface 21 facing away from the mat body 1. The non-slip coating is coated on the top surface 21 to form the non-slip layer 3. Accordingly, the outer surface of the overall structure has a high friction coefficient, thereby achieving the effect of preventing users from slipping or falling.

As to the implementation of the non-slip layer 3, the top surface 21 of the plastic film 2 is processed by electric shock or flame to form a plurality of fine dents 22, thereby destroying the flatness of the top surface 21 and increasing the surface area. When the non-slip coating is applied to the top surface 21, it can penetrate into the fine dents 22 and is tightly jointed to the plastic film 2 without peeling or detaching.

With the above structure, the present invention is characterized in that the plastic film 2 attached to the surface of the mat body 1 is configured to cover the fine pores of the mat body 1 to prevent the accumulation of dirt or dust. In addition, the top surface 21 of the plastic film 2 is processed by electric shock or flame to form a plurality of fine dents 22, so that the non-slip layer 3 is tightly joined to the plastic film 2, thereby preventing the user from slipping or falling.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An no-slip foam floor mat, comprising:
a mat body, made of a foam material;
a plastic film, attached to a surface of the mat body, the plastic film having a top surface, the top surface being processed by electric shock or flame to form a plurality of fine dents;
a non-slip layer, formed of a non-slip coating coated on the top surface of the plastic film, the non-slip coating being embedded in the fine dents and tightly joined to the plastic film.

2. The non-slip foam floor mat as claimed in claim 1, wherein the foam material of the mat body is EVA, PVC, PE or rubber.

3. The non-slip foam floor mat as claimed in claim 1, wherein the plastic film is made of PE, HDPE, PC, PP or PVC.
